(19) United States
(12) Patent Application Publication
(10) Pub. No.: US 2018/0257344 A1
(43) Pub. Date: Sep. 13, 2018

(54) Food contact item and method for manufacturing thereof

(71) Applicant: Enrico Raimondo, Cornedo Vicentino (VI) (IT)

(72) Inventor: Enrico Raimondo, Cornedo Vicentino (VI) (IT)

(21) Appl. No.: 15/779,456

(22) PCT Filed: Dec. 5, 2016
(86) PCT No.: PCT/IB2016/057359

§ 371 Date: May 25, 2018

(30) Foreign Application Priority Data
Dec. 4, 2015 (IT) 102015000080291

(51) Int. Cl. B32B 27/04; B32B 27/08

(52) U.S. Cl. CPC B32B 27/04; A47G 19/00; B32B 27/08

(57) ABSTRACT

An item having a food contact zone made of at least one fiber reinforcing laminar element embedded within a polymer matrix. In particular, the polymer matrix includes at least one base layer made of a first polymeric material and a food grade contact surface that defines the food contact surface of the contact zone. The polymer matrix is optically transparent so as to allow a user to see the reinforcing element therethrough.

### FIELD OF THE INVENTION

The present invention relates to a item having a food contact zone of composite material, as well as to a method for manufacturing such item.

### Definitions

As used herein, with the expression “fiber reinforcing laminar element” or derivative thereof of a composite material is meant a laminar element composed of a plurality of fibers, made of any natural or synthetic material, braided or woven to each other, susceptible to be embedded in a polymer matrix.

As used herein, with the expression “polymer matrix” or derivative thereof of a composite material is meant one or more polymeric materials susceptible to form the polymeric layers within which one or more fiber reinforcing laminar element are embedded.

As used herein, with the expression “transparent” or derivative thereof referred to material is meant the ability of such material to be passed through by light without being scattered.

As used herein, with the expression “translucent” or derivative thereof referred to material is meant the ability of such material to be passed through by light in a diffuse way.

As used herein, with the expression “translucent” or derivative thereof referred to material is meant the ability of such material to be passed through by light in a diffuse way.

As used herein, with the expression “food grade” or derivative thereof referred to material is meant the fact that such material meets the current legislation on food contact in a referred Country.

As used herein, with the expression “compatible materials” or derivative thereof materials are meant having chemical and/or physical compatibility to each other, that is materials which once coupled give rise to a junction adapted to support the transfer of tensile or shear stresses through the contact surface. Therefore, identical materials or in any case materials having the matrix with the same base have the maximum compatibility.

As used herein, with the expression “providing” or derivative thereof is meant the preparation of an element of interest to a process step of interest, thus including any preventive treatment act for the optimum exploiting of the same step of interest, from the simple withdrawal and possible storage to pre-heat and/or chemical and/or physical treatments and the like.

### Background of the Invention

Composite material items are known, generally composed of carbon fibers embedded in an epoxy matrix. These items are used in various fields, for example in construction, aviation, automotive, marine, medical or sports, due to the high mechanical properties and the recognized aesthetic appeal of the composite material.

However, due to the inherent inability of the composite material for food contact, such items are not usable for food contact.

In order to try to exploit the aesthetic appeal of the composite material also in this field, food material items, for example PET or aluminum cycling water bottles, coated with one or more layers of composite material have been provided. An example of such known bottles is described in the document WO2006/070267.

It is clear that these items are difficult to manufacture, expensive and not very functional. Moreover, the composite material coating tends to delaminate over time, with the consequence that it becomes not only aesthetically unpleasing, but also dangerous for people handling the item.

Further, the weight of such items is very high, which makes them unsuitable for use in competitive sports.

### SUMMARY OF THE INVENTION

Object of the present invention is to at least partially overcome the above mentioned drawbacks, by providing a high functional and low cost composite material food contact item.

Further object is to provide a food contact composite material item having high durability.

A further object is to provide a food contact composite material item having a high aesthetic appeal.

A further object is to provide a lightweight food contact composite material item.

Such objects, and others that will appear more clearly hereinafter, are fulfilled by a item and/or by a method according to what is herein described, claimed and/or shown.

Advantageous embodiments of the invention are defined in according to the dependent claims.

### BRIEF DESCRIPTION OF THE DRAWINGS

Further features and advantages of the invention will become more apparent by reading the detailed description of some preferred but not exclusive embodiments of a composite material item 1, shown as non-limiting example with the help of the annexed figures, wherein:

FIGS. 1 and 2 are axonometric views of different embodiments of the item 1;

FIG. 3 is an enlarged sectional view of some particulars of a first embodiment of the item 1;

FIG. 4 is an enlarged sectional view of some particulars of a second embodiment of the item 1.

### DETAILED DESCRIPTION OF SOME PREFERRED EMBODIMENTS

With reference to the annexed figures, it is described an item 1 suitable for food contact. In particular, the item 1 may have any shape or configuration, and may be susceptible to fully or partially contact foodstuff.

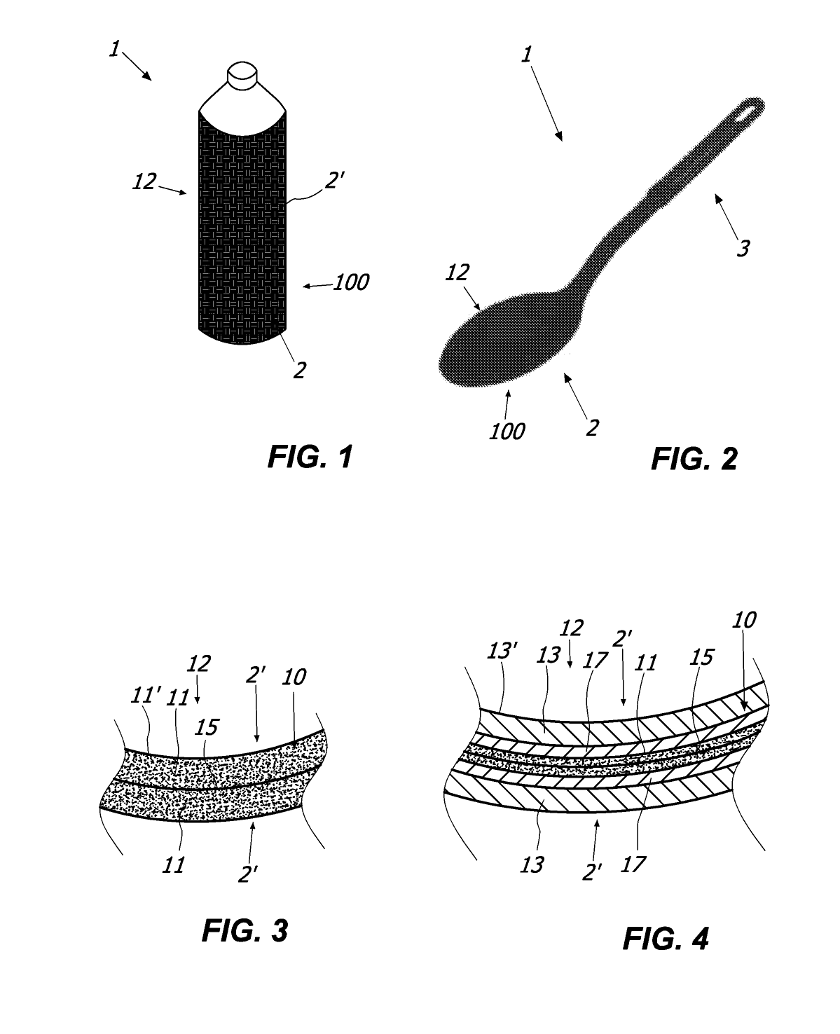

As non-limiting example, the item 1 may be cutlery, such as a fork, a knife or a spoon, as shown in FIG. 2, or a container, such as a glass, a bowl, a tray or a water bottle, as shown in FIG. 1.

On the other hand, the item 1 may be tongs for manipulating foodstuff, both manually and through a robot in an industrial line.

In particular, the item 1 may comprise a support structure 100 with at least one zone 2 made of composite material susceptible to contact foodstuff. More in detail, the zone 2 may comprise a food contact surface 2′ susceptible to contact foodstuff.

In case, for example, that the item 1 is a spoon, as shown in FIG. 2, the latter may have a concave portion defining the zone 2 made of composite material and a remaining zone 3, defining the handle, made of any material, for example the same composite material or a polymeric material or metal material.

According to a different embodiment, the whole support structure 100 or the whole item 1 may be made of composite material, as in the case of the water bottle in FIG. 1.

The food contact composite material zone 2 may be composed by at least one fiber reinforcing element 15 embedded within a polymer matrix 10.

The latter may include at least one base layer 11 made of a first thermosetting polymer material, for example an epoxy resin.

Suitably, the polymer matrix 10 may comprise a contact surface 12 which may be made of a food grade material which may define the food surface 2′ of the zone 2.

In particular, according to a first embodiment shown in FIG. 3, the contact surface 12 may be the outer surface 11′ of the base layer 11.

In such case, the first thermosetting polymer material may be a food grade material. Moreover, said first thermosetting polymer material may suitably be transparent or translucent.

In this way, it is possible to see the reinforcing elements 15 through the polymer matrix 10. This gives to the zone 2, and more in general to the item 1, a pleasant aspect.

The fiber laminar reinforcing element 15 may comprise one or more synthetic fibers and/or natural fibers. For example, said fibers may be chosen among the group consisting of carbon, glass, aramid, flax, hemp, cotton, basalt and similar fibers. Preferably, the reinforcing element may consist of carbon fibers.

The reinforcing carbon fibers 15 are embedded in the polymer matrix 10, and in particular in the layer 11 thereof, in a known way.

In particular, the fibers may be interwoven, so that the reinforcing elements 15 may have a substantially laminar development.

Suitably, the reinforcing element 15 may be completely embedded within the base layer 11 of the polymer matrix 10, so that no fiber leaks out of the same base layer 11.

In another embodiment, shown in FIG. 4, the item 1 may also comprise at least one cover layer 13 coupled with the base layer 11.

In particular, the cover layer 13 and the base layer 11 may be reciprocally coupled, so that no portion of the base layer 11 may contact the foodstuff.

In such case, the outer surface 13′ of the cover layer 13 may define a contact surface 12 of the polymer matrix 10 or, similarly, the food contact surface 2′ of the zone 2.

In such case, the base layer 11 may have the same features cited above, but it is not necessarily a food grade material. For example, said resin may be DT120 resin by Deltatech®, or IMP503 resin by Impregnatex®, or ET443/ET443 resin by C.I.T.®, or MTM28 resin by Cytec®, or a comparable similar resin.

Suitably, the cover layer 13 may be made of a food grade polymer material compatible with the first polymeric material, for example the epoxy resin Duraloid AL-30® by Prochima® or Fusion HR® resin by Withford®.

More in detail, such food grade material may have properties such as to remain unaltered also after the exposure to temperatures in the order of 60° C.-70° C. In other words, the item 1 may contact other foodstuff having a temperature comprised between −20° C. and 70° C. remaining substantially unaltered.

The food grade material may also be flexible, shock resistant and scratch resistant.

The food grade material may also keep unchanged its outer aspect during time, for example, also after several washing cycles in a dishwasher. Said food grade material may therefore resist attacks of acid and/or basic agents, for example washing detergent.

The food grade material is suitable for writing and/or screen-printing upon and/or being varnished.

The cover layer 13 may also have a particularly reduced thickness, for example a thickness lower than 0.5 mm, preferably comprised between 0.2 mm and 0.5 mm.

Possibly also the material of the base layer 11 may be susceptible to be written and/or screen-printed and/or varnished. In such case, the cover layer 13 may protect the surface 11′ of the base layer 11 in order to protect the prints, the paint works and/or the screen prints.

Suitably, also the cover layer 13 may be transparent or translucent so that the reinforcing element 15 may be seen by the user through the layers 11 and 13.

In such way, the item 1 may have a pleasant aspect.

The material of the cover layer 13 may also be compatible with the polymeric material of the base layer 11, for example it may be epoxy based too, so that the base layer 11 and the cover layer 13 may reciprocally adhere in a stable way.

As described above, the reinforcing element 15 may be completely embedded in the base layer 11 so that no portion thereof contacts the cover layer 13, so as to avoid weaken the coupling of the latter with the base layer 11.

As a possibility, the polymer matrix 10 may also include a polymeric layer 17 in order to promote the mutual adherence of the materials respectively of the base layer 11 and of the protective layer 13.

In particular, such polymeric layer 17 may be a primer agent, for example HP100N by Marbocote®, ISOMOLD by Finco®, MPP712EZ by Chem-Trend®, DURALOID 7001 by Prochima®.

Thanks to the above described features, the mutual adherence of the base layer 11 and of the cover layer 13 may be particularly so stable to give to the item 1 a uniform aspect.

Suitably, the zone 2 made of composite material may exclusively consist of one or more reinforcing elements 15 and by one or more layers of epoxy resin. In particular, in contrast with, for example, to what taught in document WO2006/070267, thermoplastic materials are not coupled with the zone made of composite material.

It is also described a method for manufacturing an item 1, in particular the zone susceptible to contact foodstuff 2.

In general, a semifinished product made of composite material may be provided comprising the fiber reinforcing laminar element 15 embedded within the base layer 11.

Subsequently, a second polymeric food grade material may be provided and may be applied on an application surface for realizing the cover layer 13, for example through a roll, brush or casting. After the application, there is a curing phase of said second polymeric food grade material so that is assumes a glassy appearance.

Said curing phase may be done in ambient air, in such case about 24 hours are necessary for the complete curing, or in oven, for example at 90° C.-100° C., in such case about 20-40 minutes are necessary.

Depending on whether the zone 2 comprises or not the primer layer 17, the application surface may be the surface of the latter or the surface of the base layer 11.

The semi-finished product made of composite material may be taken already finished from a storage site or manufactured in situ, for example by putting in a suitably shaped mould one or more laminar reinforcing elements 15 preimpregnated with the first thermosetting polymeric material and curing the latter at suitable work temperature and work time.

During the curing, the epoxy resin of the first polymeric material and/or of the second polymeric material polymerize, thus hardening and assuming a glassy appearance.

On the other hand, the one or more reinforcing laminar elements 15 may be non-preimpregnated, and the first polymeric material may be injected directly in the mould to impregnate the one or more reinforcing laminar elements 15.

A release agent may be applied in the mould to facilitate the detachment of the semi-finished product. In such case, the base layer 11 may contain a residual film of the release agent. Therefore, an appropriate phase is suitably required in which the residual film must be removed through water sandblasting at a pressure between 2 bar and 3 bar.

Such operation allows to remove the release agent film by preserving the integrity of the surface of the base element 10.

Moreover, in an embodiment, before applying the second food grade polymeric material the application surface is machined, for example by sandpaper, so as to make it rough and thus facilitating the adherence of the second polymeric material.

The machining through sandpaper may make the semi-finished product opaque.

In particular, thanks to the above-mentioned features, the item made of composite material 1 is suitable for food contact by keeping a very pleasant aesthetica) appeal. The item 1 is light, manageable and resistant, particularly suitable for competitive sport purposes.

The invention will be better understood in the light of the following example.

### Example

To manufacture a cup according to this invention, it is required to insert the following elements in a mould:
1 skin at +/−45° of carbon fiber-fabric-200gmq-T300;
1 skin at 0/90° of carbon fiber-fabric-2380gmq-T700;
1 skin at +/−45° of carbon fiber-fabric-200gmq-T300;
1 skin at +/−45° of carbon fiber-fabric-200gmq-T300.

All skins are pre-impregnated with transparent epoxy resin.

Then, a vacuum compaction is performed for 10 min at 60°, thereafter the mould is closed, it is placed under vacuum and the whole is treated in an autoclave for 2 hours at 135° C., with a heating of 2° C. per minute and a next cooling of 3° C. per minute.

Once the semi-finished product is removed from the mould and burrs are trimmed, the internal surface is made opaque through a treatment with sandpaper and the resulting surface is cleaned through an epoxy diluent.

Once the surface has dried, it is therefore applied, inside the cup and through a brush, a layer of about 0.4 mm of food grade transparent epoxy resin, and the latter undergoes curing in ambient air for about 24 hours.

After the curing, the layer of food grade epoxy resin assumes a glassy appearance. It is possible to see the carbon skins both through the external surface and the internal one of the cup.

The invention claimed is:

1.-23. (canceled)

24. A food contact item comprising:
a support structure having at least one zone with a food contact surface adapted to contact a foodstuff,
wherein said at least one zone comprises at least one fiber reinforcing element embedded within a polymer matrix to define a composite material, the polymer matrix including at least one base layer made of a first polymeric thermosetting material,
wherein said food contact surface of said at least one zone is made of the composite material.

25. The item according to claim 24, wherein said polymer matrix consists of said at least one base layer, said at least one base layer including an outer surface providing said food contact surface, said first polymeric material being a transparent or translucent food grade epoxy resin.

26. The item according to claim 24, wherein said polymer matrix further comprises at least one cover layer coupled with said at least one base layer, said at least one cover layer including an outer cover surface, said at least one cover layer being made of a second food grade polymeric material compatible with said first polymeric material of said at least one base layer, said first polymeric material and said second polymeric material being both transparent or translucent, said outer cover surface of said at least one cover layer defining said food contact surface.

27. The item according to claim 26, wherein said first polymeric material is a first epoxy resin, and wherein said second polymeric material is a second food grade epoxy resin.

28. The item according to claim 26, wherein said polymer matrix further includes at least one layer of a primer agent interposed between said at least one base layer and said at least one cover layer.

29. The item according to claim 28, wherein said polymer matrix consists of said at least one base layer and said at least one cover layer; or of said at least one base layer, said at least one layer of a primer agent, and said at least one cover layer.

30. The item according to claim 26, wherein said at least one cover layer has a thickness of at least 0.2 mm.

31. The item according to claim 24, wherein said at least one fiber reinforcing element is completely embedded within the first polymeric material of said at least one base layer.

32. The item according to claim 24, wherein said at least one fiber reinforcing element comprises fibers selected from the group consisting of carbon fibers, glass fibers, aramid fibers, natural fibers, or a combination thereof.

33. The item according to claim 24, wherein said at least one zone consists of said at least one fiber reinforcing element and at least one layer of an epoxy polymeric material.

34. The item according to claim 24, wherein said at least one zone is free of thermoplastic polymer materials.

35. The item according to claim 24, wherein said support structure is entirely made of a composite material.

36. The item according to claim 24, wherein the item is selected among the group consisting of a tray, a bottle, a water bottle, a cover, a kitchen utensil, and a forceps for handling foodstuffs.

37. A method of manufacturing a food contact item comprising a support structure with at least one zone made of a composite material, said support structure having a food contact surface adapted to contact a foodstuff, the method comprising a step of manufacturing said at least one zone by:
providing a semifinished product made of the composite material comprising at least one fiber reinforcing element embedded within at least one base layer made of a first thermosetting polymeric material;
providing a second polymeric food grade material compatible with said first thermosetting polymeric material; and
applying at least one cover layer made from said second polymeric food grade material on an application surface arranged above said at least one base layer so as to obtain said food contact surface adapted to contact said foodstuff,
wherein said first polymeric material and said second polymeric material are both transparent or translucent so as to allow a user to see the at least one fiber reinforcing element through said at least one base layer and said at least one cover layer.

38. The method according to claim 37, wherein said second polymeric material is a food grade epoxy resin, the method further comprising a step of curing said second polymeric material to cause said second polymeric material to assume a glassy appearance.
